(19) United States
(12) Patent Application Publication
(10) Pub. No.: US 2004/0180988 A1
(43) Pub. Date: Sep. 16, 2004

(54) High dielectric constant composites

(76) Inventors: Mark T. Bernius, Midland, MI (US); Ray E. Drumright, Midland, MI (US); Michael J. Elwell, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/791,408

(22) Filed: Mar. 2, 2004

Related U.S. Application Data
(60) Provisional application No. 60/453,780, filed on Mar. 11, 2003.

(51) Int. Cl. C03C 17/00; C09D 5/00; C08K 3/08

(52) U.S. Cl. 523/160; 524/440; 523/161

(57) ABSTRACT

The subject invention provides a composite comprising stabilized conductive nanoparticles dispersed within a polymer matrix. The dielectric constant of the composites is advantageously high, exceeding that predicted by the rule of mixtures. The subject invention further provides a film comprising such composites. Such films will enjoy applicability in electronics applications. The subject invention additionally provides a thin film organic transistor comprising the inventive composite. The subject invention further provides processes for stabilizing conductive nanoparticles.

### CROSS-REFERENCE STATEMENT

This application claims the benefit of U.S. Provisional application No. 60/453,780 filed Mar. 11, 2003.

### FIELD OF THE INVENTION

The subject invention pertains to high dielectric constant composites, processes for their fabrication, and uses therefor.

### BACKGROUND OF THE INVENTION

Various electronic applications require the induction of electrical polarization without electrical conduction. Such applications include capacitive dielectrics, gate insulators in thin film transistors and field-effect transistor circuitry, and “on-board” chip memory.

Compositions in which electrical polarization may be induced, but which remain non-conductive, are known. For instance, polymers that primarily possess a dielectric constant between 2 and 4 have been employed. Such polymers include polymethylmethacrylate, benzocyclobutene, Parylene-C aromatic polymer (available from Union Carbide Corporation), polyimides, and polyhydroxystyrene.

To enhance the electrical conductivity of polymeric materials, composites of conductive particles in polymeric matrices have been employed. One class of such compositions includes conductive carbon-filled polymers. For example, inner wire insulation is known which employs a conductive carbon-filled polyethylene as a corona barrier. Further, plastics infused with carbon black have been employed in anti-static devices for use in the electronics industry. For example, polyurethane loaded with a high volume of conductive carbon is commercially available from Foster Corporation (Dayville, Conn.) for use in static dissipative plastic housings for electronics. Other suppliers of conductive-carbon filled polymer materials include Goodfellow Cambridge Limited (Huntingdon, England), Degussa AG (Dusseldorf, Germany) and Cabot Corporation (Boston, Mass.).

A second class of such composites includes ceramic-filled polymers. JP 199307911 A discloses the dispersion in an epoxy resin of greater than 30 weight percent by volume of 10 to 40 micron particles of barium titanate. Kokai H-461705 discloses the dispersion in a polymer of particles having a maximum particle diameter of 10 to 500 microns of a perovskite-type compound and titanium dioxide. Kokai H-2206623 discloses a high dielectric constant film comprising an aromatic polyamide or polyimide in which 5 to 90 volume percent of an inorganic filler is provided. A surfactant or a dispersing agent or coupling agent is provided to improve the miscibility of the polymer and the inorganic filler. EP 09902048 discloses a flexible polyimide film having a dielectric constant from 4 to 60, which contains between 4 and 85 weight percent ceramic filler. JP Sho-63213563 discloses the precipitation of a high dielectric constant oxide material from an acidic aqueous solution containing lead, calcium and titanium, by the addition of an alcohol solution of oxalic acid. The resultant precipitate may be sintered and dispersed in an elastomer and/or polymer resin.

The carbon- and ceramic-based composites are disadvantageously highly loaded, for example, up to 50/50 percent vol/vol. Such high loadings render the systems paste-like, and too viscous to permit processing via solution-based film forming techniques.

As disclosed by M. Bockstaller and E. Thomas in Polymer Preprints 2002, 43(1), 6, pp. 6-7 and by M. Bockstaller, R. Kolb, and E. Thomas in Adv. Mater. 2001, 133, No. 23, pp. 1783-1786, metallodielectric photonic crystals are known. The described photonic crystals comprise gold nanoparticles compatibilized by thiol-terminated oligo(styrene) ligands and are dispersed in a block copolymer matrix. The publications do not suggest the utility of the prepared compositions in electronic applications. Moreover, the publications do not teach or suggest increasing the amount of gold nanoparticles within the compositions to raise the dielectric constant.

As disclosed by T. A. Osswald and G. Menges in Materials Science of Polymers for Engineers, Hanser/Gardner Publications, Inc. (1995), pp. 388-389, the effect of fillers on the relative dielectric constant of a polymeric matrix may be predicted by the rule of mixtures. Specifically, in the case of composites of metal fillers in a matrix, the rule of mixtures predicts that the dielectric constant of the composite will satisfy the following equation:

κ_{eff}=κₘₐₜᵣᵢₓ*(1+3Φ),

where κ_{eff} is the dielectric constant of the composite, κₘₐₜᵣᵢₓ is the dielectric constant of the matrix material and Φ is the volume fraction of the metal particles within the composite. According to the rule of mixtures, it would be unexpected for the dielectric constant of the composite to exceed κₘₐₜᵣᵢₓ*(1+3Φ).

Recently, composites of conductive particles in polymer matrices exhibiting dielectric constants of greater than 100 have been reported by Rao, Y., et al., in WO 02/088225.

WO 02/088225 discloses providing conductive particles having particle sizes in the range of from 0.5 to 50 microns (0.1 to 10 microns, in the case of silver), at a loading of 5 to 50 (1 to 40, in the case of silver) volume percent of the polymer composite. However, WO 02/088225 does not teach or suggest solution-processible composites useful in thin films for electronic applications.

There is a great need in industry for compositions which permit organic transistors to operate at lower voltages, and thus at reduced power requirements. Such compositions should withstand a high degree of applied voltage without conduction or breakdown, and impart an induced polarization to the active semiconducting medium to facilitate low-power operation. Such compositions should have a dielectric constant that exceeds that which is predicted by the rule of mixtures, and will preferably have a dielectric constant of at least 8, typically from 8 to 100. Such compositions should be compatible with organic transistor systems, and with conventional and emerging print manufacturing processes. Preferably, such compositions will be formable into continuous layers that are less than 3 microns thick.

### SUMMARY OF THE INVENTION

Accordingly, the subject invention provides a composite comprising a poly(methyl methacrylate) matrix having dispersed therein conductive transition metal nanoparticles, which dispersion is stabilized by a thiol-functionalized stabilizing agent, wherein the difference between the solubility parameter of the poly(methyl methacrylate) and the stabilizing agent is less than or equal to 3.

The subject invention further provides a process for preparing a composite, comprising: (a) providing a solution of a metal ion and a stabilizing agent precursor in a solvent; (b) forming stabilized conductive nanoparticles by adding to said solution a reducing agent, whereby said metal ion is reduced to elemental metal and said stabilizing agent precursor is reduced to a stabilizing agent; (c) isolating said stabilized conductive nanoparticles from said solvent; (d) preparing a composite solution of said stabilized conductive nanoparticles and a matrix polymer; and (e) isolating said composite from said composite solution.

The polarizable, non-conductive film of the invention will find utility in a host of electronic applications, including but not limited to use in capacitive dielectrics, gate insulators in thin film transistors and field-effect transistor circuitry, and “on-board” chip memory.

### BRIEF DESCRIPTION OF THE FIGURES

FIG. 1 illustrates an organic thin film transistor of the invention.

FIG. 2 illustrates the configuration of the capacitor assembly prepared to measure the dielectric constant of the composites of the invention.

FIG. 3 provides a graphical representation of the dielectric constant of composites of the invention as a function of the volume fraction of gold in the composite.

FIG. 4 provides a graphical representation of the resistance of composites of the invention as a function of the volume fraction of gold in the composite.

### DETAILED DESCRIPTION OF THE INVENTION

“Matrix Polymers” are polymers. Matrix polymers will typically have a dielectric constant of at least 2, more typically at least 3, measured at room temperature and at a frequency of 1 MHz. Matrix polymers will typically have a dielectric constant of less than 8, more typically less than 4, measured at room temperature and at a frequency of 1 MHz. As used herein, dielectric constant is determined in accordance with the test procedure set forth in the Examples below. Particularly when high temperature processing of the composites of the invention is required, that is, processing at a temperature in excess of 200° C., the matrix polymer will preferably be a thermosetting polymer. This can take the form of a B-staged material, wherein the conversion of the monomers is advanced to a defined and controlled value which is lower than the value at which the system would reach the onset of chemical gelation. Upon application of such partially cured materials to a substrate, the material may be more fully cured.

A list of matrix polymers is set forth in Table 11.2, Chapter 11, D. W. Van Krevelen, Properties of Polymers, 3^{rd} Ed., Elsevier, Amsterdam, 1990. A representative but non-limiting list of matrix polymers includes polyethylenes, polystyrenes, polymethylmethacrylates, polyesters, polyethers, polyamides, aromatic polyethers, aromatic polyamides, thermoplastic epoxy resins, linear and non-linear lightly crosslinked copolyurethanes, and mixtures thereof.

“Conductive nanoparticles” are particles having a conductivity of at least 100 (ohm-cm)⁻¹ which are dispersible in the matrix polymer. Conductive nanoparticles will typically have an average particle size of less than 0.1 microns, preferably less than 0.05 microns, more preferably less than 0.025 microns, and most preferably less than 0.005 microns. Conductive nanoparticles will have an average particle size of at least 0.001 microns, typically of at least 0.002 microns, although average particle sizes of 0.003 microns or greater may be employed. Representative conductive nanoparticles include metals. Particularly preferred conductive nanoparticles include transition metals and alloys thereof. Especially preferred conductive nanoparticles include aluminum, copper, gold, manganese, molybdenum, nickel, palladium, platinum, tin, zinc, tantalum, titanium and silver. Even more preferred conductive nanoparticles include gold, silver and palladium. An especially preferred conductive nanoparticle is gold.

Conductive nanoparticles may be synthesized by processes known in the art. For instance, traditional processes for preparing nanoparticles are disclosed in Brust, M., et al., J. Chem. Soc. Chem. Commun., 801 (1994); Leff, D. V., et al., J. Phys. Chem., 99, 7036 (1995); Yee, C. K., et al., Langmuir, 15, 3486 (1999); Yonezawa, T, et al., Langmuir, 17, 271, (2001); Schriffin, D. J., et al., MRS Bulletin, 26(12), 1015 (2001); Mossmer, S., et al., Macromolecules, 33, 4791 (2000), and Djallali, R., et al., Macromolecules, 35, 4248 (2002).

Left untreated, conductive nanoparticles would tend to agglomerate. Further, left untreated, conductive nanoparticles would tend to be incompatible with the polymer matrix, rendering the composite prone to undergo macrophase separation, with the dispersed phase of conductive nanoparticles typically exhibiting a length scale of greater than or equal to 1000 nm. Thus, to permit the formation and maintenance of the very small particle size of the conductive nanoparticles, and of the dispersion of the conductive nanoparticles in the matrix polymer, the conductive nanoparticles will preferably be reacted with a stabilizing agent to form stabilized conductive nanoparticles. In one embodiment, the stabilizing agent will have a first portion having a high affinity for the conductive nanoparticles and a second portion having a high affinity for the polymer matrix. Such dual functionality will permit the stabilized conductive nanoparticles to be sterically and chemically stabilized within the polymer matrix.

The stabilizing agent will be selected based upon the properties of the conductive nanoparticles and the polymer matrix. In selecting an appropriate stabilizing agent, the adages that “like dissolves like” and “like will stabilize like” provide instructive guidance. Specifically, the stabilizing agent will preferably be similar to the matrix polymer and any solvent in which the composite will be dissolved, in terms of both chemical composition and molecular size. Examples of preferred solvents, especially for ink applications, include propyleneglycolmonomethylether acetate (PGMEA, which is commercially available as DOWANOL glycol ethers from The Dow Chemical Company), ethyl acetate, isopropyl acetate, butyl acetate, tetrahydrofuran, toluene, xylenes, and mesitylenes. In terms of chemical composition, the difference between the solubility parameter of the matrix polymer and the stabilizing agent will preferably be less than 3, more preferably less than 2. Values of the solubility parameter for simple liquids can be readily calculated from the enthalpy of vaporization. This approach cannot be used for a polymer; one must result to comparative techniques. Such techniques are described in Cowie, J. M. G.; Polymers: Chemistry and Physics of Modern Materials, Intertext Books, (1973), pp. 143-144. In terms of molecular size, the thickness of the polymer shell surrounding the particle should be about 2 times the radius of gyration of the stabilizing agent molecule. The radius of gyration may be measured using neutron scattering or light scattering techniques.

U.S. Pat. No. 6,277,740, incorporated herein by reference, provides additional teaching regarding the dispersion of nanoparticles in a solvent. For additional general instruction on the selection of stabilizing agents, see, for example, Billmeyer, F. W., Textbook of Polymer Science, 3rd Ed., Wiley, New York, (1984); Billingham, N.C., Molar Mass Measurements in Polymer Science, Kogan Page Publishers, (1977); Tanford, C., Physical Chemistry of Macromolecules, John Wiley & Sons, New York, (1961); Gedde, U. W., Polymer Physics, Kluwer Academic Publishers, Dordrecht, (1995); and Van Krevelen, D. W., Properties of Polymers, 3rd Ed., Elsevier, Amsterdam, (1990).

Particularly preferred stabilizing agents include functionalized oligomers and polymers of a variety of different shapes, sizes and compositions. Functionalized linear and branched homopolymers, random copolymers, block and graft copolymers, condensation polymers, addition polymers, polymer brushes, polymer mushrooms, and dendrimers, and mixtures thereof, are particularly preferred. When gold is selected as the conductive nanoparticle, sulfur functionalized oligomers are preferred stabilizing agents.

Sulfur functionalized stabilizing agents will preferably fall into one of three categories. Category I stabilizing agents comprise a monomeric, oligomeric or polymeric chain bearing a single thiol group. Category II stabilizing agents comprise a monomeric, oligomeric or polymeric chain terminated at a plurality of ends by a thiol group. Category III stabilizing agents comprise an oligomeric or polymeric chain having thiol-terminated branches pendant to and distributed along the oligomer or polymer backbone.

Thiols may be used directly as Category I stabilizing agents. Non-polymeric and non-oligomeric thiol-terminated compounds include compounds corresponding to the formula:

R—SH,

wherein R is a C₂ or greater, typically a C₆-C₂₀ substituted or unsubstituted aliphatic, cycloaliphatic or aromatic fragment. Exemplary non-polymeric and non-oligomeric thiol-terminated compounds include dodecanethiol and octadecylthiol.

Alternatively, Category I stabilizing agents may be prepared by reducing disulfide-containing stabilizing agent precursors to generate corresponding thiol-terminated fragments. Exemplary disulfide-containing stabilizing agent precursors include, for example, propyl disulfide, isopropyl disulfide, sec-butyl disulfide, t-butyldisulfide, allyl disulfide,

2-hydroxyethyldisulfide, 1,2-dithian-4,5-diol, benzyl methyl disulfide, 2,4,5-trichlorophenyl disulfide, phenyl disulfide, tolyl disulfide, benzyl disulfide, 6-hydroxy-2-napthyldisulfide, octadecyl disulfide, and dodecyl disulfide. Preferred disulfide-containing stabilizing agent precursors include 2,4,5-trichlorophenyl disulfide, phenyl disulfide, tolyl disulfide, benzyl disulfide, 6-hydroxy-2-napthyldisulfide, octadecyl disulfide, and dodecyl disulfide.

In a more preferred embodiment, precursors to Category I stabilizing agents may be prepared by reacting an initiator containing a sulfur-sulfur bond with a cyclic monomer in a ring-opening polymerization reaction to form an oligomeric or polymeric reaction product stabilizing agent precursor. Upon reduction of the reaction product stabilizing agent precursor, thiol-containing stabilizing agent chains would result. In this embodiment, the initiator employed will have at least one sulfur-sulfur bond, and will correspond to one of the following two formulas:

X¹ₐ—R¹—S—S—R¹—X¹_{b} or

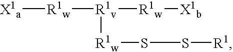

wherein each R¹ group is independently a substituted or unsubstituted C₁-C₅₀, preferably C₁-C₂₀, and most preferably C₂-C₁₅ aliphatic, cycloaliphatic or aromatic fragment, and where two or more R¹ groups may be optionally joined to form a ring; and

wherein each X¹ group is independently a moiety bearing an active hydrogen, preferably —OH, —NH₂, —NHR, —SH, —COOH, with R being a C₁ or greater, typically a C₁₋C₆ substituted or unsubstituted aliphatic, cycloaliphatic or aromatic fragment; and

wherein a and b are independently integers, with the sum of a and b being at least 1.

wherein each w is independently 0 or 1;

wherein v is an integer of at least 1.

Representative initiators include 2-hydroxyethyldisulfide, 1,2-dithian-4,5-diol, and 3-methyldisulfanyl-propane-1,2-diol.

The cyclic monomer employed will correspond to the formula:

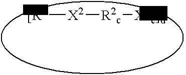

wherein each X² group is independently —C(O)NH—, —C(O)NR—, —OC(O)NH—, —OC(O)NR, —NHC(O)NH—, —NHC(O)NR—, —NRC(O)NR—, —C(O)O—, —OC(O)O—, —O—, —NH—, —NR—, or —S—, with R being a C₁ or greater, typically a C₁-C₆ substituted or unsubstituted aliphatic, cycloaliphatic or aromatic fragment;

wherein each R group is independently a substituted or unsubstituted C₁-C₅₀, preferably C₁-C₂₀, and most preferably C₅-C₁₅ aliphatic, cycloaliphatic or aromatic fragment or —SiR₂—, with each R being independently a C₁ or greater, typically a C₁-C₆ substituted or unsubstituted aliphatic, cycloaliphatic or aromatic fragment;

wherein each c is independently an integer from 0 to 1; and

wherein d is a number that is at least 1.

Exemplary cyclic monomers include cyclic esters, epoxides, lactides, cyclic carbonates, cyclic amides, cyclic urethanes, and cyclic siloxanes. Specifically, ε-caprolactone, lactide, glycolide, ε-caprolactam, propylene oxide, ethylene oxide, trimethylene carbonate, 2,2-dimethyltrimethylene carbonate, 1,4-dioxane-2-one, 1,5-dioxepane-2-one, cyclic bisphenol-A carbonate, hexamethylcyclotrisiloxane, octamethylcyclotetrasiloxane, and cyclic butylene terephthalate are representative cyclic monomers that may be employed.

One preferred example of the preparation of a stabilizing agent of Category I involves the reaction of bis(2-hydroxyethyl)disulphide with ε-caprolactone to form a reaction product stabilizing agent precursor, and subsequent reduction of the reaction product stabilizing agent precursor to produce a thiol-terminated oligomeric or polymeric stabilizing agent chain of the following formula:

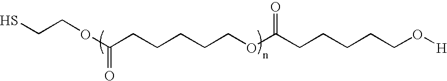

wherein n is the number average degree of polymerization, and, in the case of the average length polymer chain, n is a number from 0 to 500, preferably from 0 to 20, more preferably from 1 to 10.

Thiol-functionalized polycaprolactone is an especially preferred stabilizing agent. The sulfur moieties advantageously anchor the stabilizing agent to gold surfaces, while polycaprolactone is widely compatible with numerous matrix polymers, including but not limited to polystyrene. When the matrix polymer comprises two incompatible polymers, the thiol-functionalized polycaprolactone will preferably serve the dual function of stabilizing the conductive nanoparticles and compatibilizing the two polymers of the matrix polymer.

Category II stabilizing agents may be prepared by reacting: (1) a first monomer containing at least one sulfur-sulfur bond, (2) a second monomer terminated at each end by a moiety bearing an active hydrogen, and (3) an acid, acid chloride, acid anhydride, isocyanate, epoxide or glycidyl ether to form a reaction product stabilizing agent precursor, and reducing the reaction product stabilizing agent precursor.

Suitable first monomers will have at least one sulfur-sulfur bond, and will correspond to the formula:

X³ₑ—R³—S—S—R³—X³_{f}

wherein each R³ group is independently a substituted or unsubstituted C₁-C₅₀, preferably C₁-C₂₀, and most preferably C₂-C₁₅ aliphatic, cycloaliphatic or aromatic fragment, and where two R³ groups may be optionally joined to form a ring;

wherein each X³ group is independently a moiety bearing an active hydrogen, preferably —OH, —NH₂, —NHR, —SH, or —C(O)OH, with R being a C₁ or greater, typically a C₁-C₆ substituted or unsubstituted aliphatic, cycloaliphatic or aromatic fragment; and

wherein e and f are independently integers and the sum of e and f is at least 1.

Suitable second monomers will correspond to the following formula:

A⁴-[R⁴-X⁴_{g}—R⁴_{g}—X⁴_{g}]ₕ—R⁴_{g}-A⁴,

wherein each A⁴ group is independently a moiety bearing an active hydrogen, preferably —OH, —NH₂, —NHR, or —SH, with R being a C₁ or greater, typically a C₁—C₆ substituted or unsubstituted aliphatic, cycloaliphatic or aromatic fragment;

wherein each X⁴ group is independently —C(O)NH—, —C(O)NR—, —OC(O)NH—, —OC(O)NR—, —NHC(O)NH—, —NHC(O)NR—, —NRC(O)NR—, —C(O)O—, —OC(O)O—, —O—, —NH—, —NR—, or —S—, with each R being independently a C, or greater, typically a C₁-C₆ substituted or unsubstituted aliphatic, cycloaliphatic or aromatic fragment;

wherein each R⁴ group is independently a substituted or unsubstituted C₁-C₅₀, preferably C₁-C₂₀, and most preferably C₂-C₁₅ aliphatic, cycloaliphatic or aromatic fragment, or —Si(R)₂—, with each R being independently a C₁ or greater, typically a C₁-C₆ substituted or unsubstituted aliphatic, cycloaliphatic or aromatic fragment;

wherein each g is independently an integer from 0 to 4; and

wherein h is a number that is at least 1.

Exemplary second monomers include diols, diamines, glycols, polyesters, polyethers, and siloxanes. Specifically, ethylene glycol, butane diol, poly(propylene oxide), poly(ethylene oxide), poly(caprolactone), 1,6-hexane diamine, poly(tetramethylene oxide), poly(dimethyl siloxane), and poly(butadiene) diol, poly(butyleneadipate), poly(ethylene butylene adipate), poly(hexamethylene 2,2-dimethylpropylene adipate), poly(diethylene glycol adipate), and poly(hexanediol carbonate) are representative second monomers that may be employed.

Suitable acids, acid chlorides, isocyanates, epoxides, and glycidyl ethers will correspond to the following formula:

Z⁵ᵢ-R⁵-Z⁵ᵢ,

wherein the R⁵ group is a substituted or unsubstituted C₁-C₅₀, preferably C₁-C₂₀, and most preferably C₂-C₁₅ aliphatic, cycloaliphatic or aromatic fragment;

wherein each Z⁵ group is independently —C(O)OH, —C(O)Cl, —NCO, epoxide, or glycidyl ether; and

each i is independently an integer from 1 to 4. Acid anhydrides of the foregoing acids may be similarly employed.

Exemplary acids, acid chlorides, acid anhydrides, isocyanates, epoxides and glycidyl ethers include terephthalic acid, isophthalic acid, phthalic acid, adipic acid, succinic acid, maleic acid, cyclohexane dicarboxylic acid, terephthaloyl chloride, isophthaloyl chloride, phthaloyl chloride, adipoyl chloride, phthalic anhydride, succinic anhydride, maleic anhydride, pyromellitic anhydride, methylene diphenyl diisocyanate (MDI), toluene diisocyanate (TDI), isophorone diisocyanate (IPDI), hexamethylene diisocyanate (HDI), and bisphenol-A diglycidyl ether (DGEBA or BADGE).

It should be noted that, alternatively, the acid, acid chloride, isocyanate, epoxide, or glycidyl ether may correspond to the following formula:

Z⁶ⱼ-R⁶—S—S—R⁶-Z⁶ₖ,

wherein each R⁶ group is independently a substituted or unsubstituted C₁-C₅₀, preferably C₁-C₂₀, and most preferably C₂-C₁₅ aliphatic, cycloaliphatic or aromatic fragment;

wherein each Z⁶ group is independently —C(O)OH, —C(O)Cl, —NCO, epoxide, or glycidyl ether; and

each of j and k is independently an integer from 0 to 4 and the sum of j and k is at least 1.

Anhydrides of the foregoing acids may be likewise employed. When acids, acid chlorides, isocyanates, epoxides, glycidyl ethers or acid anhydrides containing a sulfur-sulfur bond are employed, the first monomer would be rendered optional since the oligomer or polymer would contain sulfur-sulfur bonds attributable to the acid, acid chloride, acid anydride, isocyanate, epoxide, or glycidyl ether.

Representative specific examples of Category II stabilizing agents involve the reaction of bis(2-hydroxyethyl)disulphide with butane diol and adipic acid, and subsequent reduction of the reaction product stabilizing agent precursor to produce a thiol-terminated oligomeric or polymeric stabilizing agent corresponding to the following structure:

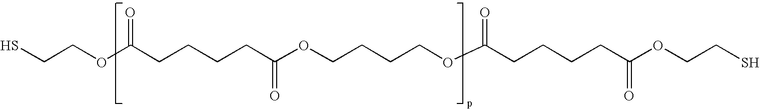

the reaction of bis(2-hydroxyethyl)disulphide with butane diol and methylene diphenyl diisocyanate, and subsequent reduction to produce a thiol-terminated polyurethane reaction product stabilizing agent corresponding to the following structure:

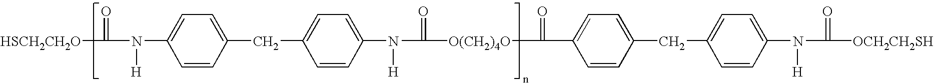

the reaction of bis(2-aminoethyl)disulphide with 1,6-hexanediamine and adipic acid, and subsequent reduction of the reaction product to produce a polyamide reaction product stabilizing agent corresponding to the following structure:

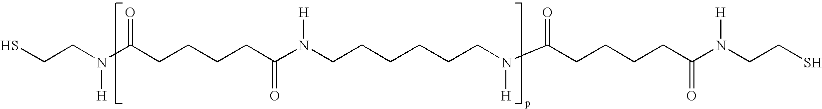

In each of the three foregoing structures, p is the number average degree of polymerization, and, in the case of the average length polymer chain, p is a number from 0 to 500, preferably from 0 to 20, more preferably from 1 to 10.

By analogy, other polymeric or oligomer stabilizing agent precursors may be prepared, as will be readily apparent to those of ordinary skill in the art. Examples include other disulfide-containing polyesters, polyamides, and polyurethanes, as well as disulfide-containing polyureas, polyethers, polycarbonates, polyester amides, polyester ethers, polyimides, and thermoplastic epoxies.

Category III stabilizing agents may be prepared by reacting (1) a first monomer containing at least one structopendant moiety containing sulfur-sulfur bond, (2) a second monomer terminated at each end by a moiety having an active hydrogen, and (3) an acid, acid chloride, acid anhydride, isocyanate, epoxide, or glycidyl ether in a polymerization reaction, and reducing the reaction product stabilizing agent precursor. As used herein, “structopendant” means a branch that is pendant from a monomer, such that, when such monomer is polymerized, the branch is pendant from the polymer backbone.

In this embodiment, illustrative first monomers containing at least one structopendant moiety containing a sulfur-sulfur bond will correspond to the following formula:

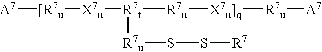

wherein each A⁷ group is independently a moiety bearing an active hydrogen, preferably —OH, —NH₂, —NHR, —SH, or —C(O)OH, with R being a C₁ or greater, typically a C₁-C₆ substituted or unsubstituted aliphatic, cycloaliphatic or aromatic fragment;

wherein each X⁷ group is independently —C(O)NH—, —C(O)NR—, —OC(O)NH—, —OC(O)NR, —NHC(O)NH—, —NHC(O)NR—, —NRC(O)NR—, —C(O)O—, —OC(O)O—, —O—, —NH—, —NR—, or —S—, with each R group being independently a C₁ or greater, typically a C₁-C₆ substituted or unsubstituted aliphatic, cycloaliphatic or aromatic fragment;

wherein each R⁷ group is independently a C₁-C₅₀ substituted or unsubstituted aliphatic, cycloaliphatic or aromatic fragment, preferably a C ₁-C₁₅ substituted or unsubstituted linear aliphatic, cycloaliphatic or aromatic fragment; and

wherein each u is independently 0 or 1;

wherein t is an integer of at least 1; and

wherein q is an integer from 1 to 3000.

Suitable second monomers and suitable acids, acid chlorides, acid anhydrides, isocyanates, epoxides, or glycidyl ethers are as described above with respect to Category II stabilizing agents.

A representative specific example of the preparation of a Category III stabilizing agent involves the reaction of 3-methyldisulfanyl-propane-1,2-diol with butane diol and adipic acid to produce a stabilizing agent precursor comprising a random co-polyester having pendant branches containing sulfur-sulfur linkages, and having the following repeating units:

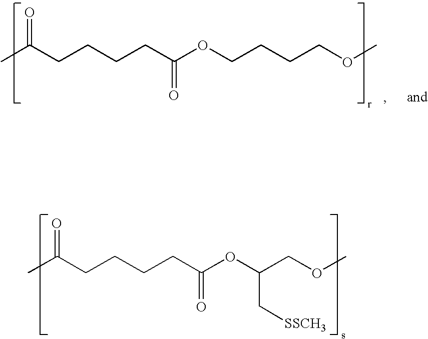

Such repeating units may be arranged in any number of ways, and may vary from polymer chain to polymer chain. In each case, the average values of r and s will independently be numbers, with s being a number of at least 1. The sum of the average value of r and the average value of s within the polymer will be a number from 1 to 500, preferably from 1 to 20, more preferably from 1 to 10.

When such disulfide-containing polymer is reduced, methylmercaptan would be liberated and a stabilizing agent comprising a polymer substituted with thiol-terminated branches would result.

Analogously, a monomer such as 3-methyldisulfanylpropene could be used to place pendant thiol functionality on a polymer prepared from unsaturated monomers, such as polystyrene or polymethylmethacrylate.

When silver is selected as the conductive nanoparticle, sulfur-functionalized oligomers and polymers may be employed as the stabilizing agent. Alternatively, stabilizing agents may possess an active oxygen. Such stabilizing agents include polyethers, crown ethers, and cryptands.

As will be apparent to those of skill in the art, mixtures of Category I, Category II and Category III stabilizing agents (or precursors thereto) may be employed. Likewise, in the preparation of Category I, Category II and Category III stabilizing agent precursors, mixtures of reactants may be employed; that is, a plurality of first monomers, a plurality of second monomer, a plurality of initiators, a plurality of acids or acid chlorides, and so on.

In one preferred embodiment, a Category I, Category II or Category III stabilizing agent will be supplemented by a Category I thiol, as described above. For example, in one preferred embodiment, the stabilizing agent will comprise the reaction product of an oligomeric or polymeric stabilizing agent precursor and a reducing agent, in the presence of a non-oligomeric and non-polymeric thiol-terminated compound. While not wishing to be bound by theory, it is believed that in this embodiment, the non-oligomeric and non-polymeric thiol-terminated compound will serve to stabilize the size of the conductive nanoparticles, while the resultant oligomeric or polymeric stabilizing agent will serve to compatibilize the conductive nanoparticle within the matrix polymer.

The stabilizing agent may be associated with the conductive nanoparticle in a variety of manners. For example, the stabilizing agent may be associated with the conductive nanoparticle by ionic interaction, chemical bonding, grafting, physical association (such as hydrogen bonding), and physical adsorption onto the surface of the conductive nanoparticle.

By appropriately designing the synthetic strategy for the stabilized conductive nanoparticle, the average particle size and the particle size distribution of the stabilized conductive nanoparticle within the composite may be controlled. In a particularly preferred embodiment, the compatibilization mechanism will involve the simultaneous reduction of an ionic precursor to the conductive nanoparticle and di-sulfide bond of the stabilizing agent precursor. In this embodiment, an ionic precursor of the conductive nanoparticle is typically dissolved in a suitable solvent such as water, alcohol or a blend of alcohols, or polar solvent. To this solution, the stabilizing agent precursor is added. A reducing agent is then added to cleave the sulfur-sulfur bonds of the stabilizing agent precursor to form thiol groups and to reduce the metallic ion to elemental metal. The ions and other detritus from the synthesis are removed and the stabilized conductive nanoparticles are either isolated or separated (such as by extraction) into a selective solvent in which the stabilizing agent is soluble.

In the preferred case in which the conductive nanoparticle is gold, a preferred ionic precursor is hydrogen tetrachloroauric acid trihydrate. In such a preferred case, exemplary but non-limiting solvents for dissolving the ionic precursor will include de-ionized water and tetrahydrofuran. Exemplary but non-limiting reducing agents for hydrogen tetrachloroauric acid trihydrate include sodium borohydride and lithium triethylborohydride (superhydride).

As disclosed by Brust, M., et al., J. Chem. Soc. Chem. Commun., 801 (1994), the particle size and particle size distribution of the conductive nanoparticles may be controlled by adjusting the molar ratio of the conductive nanoparticle and the stabilizing element of the stabilizing agent (sulfur, in the case of thiol-functionalized stabilizing agents). As the number of molecules of stabilizing agent is reduced, the propensity for agglomeration of the conductive nanoparticles increases. The ratio between the stabilizing agent and the conductive nanoparticle will preferably be chosen such as to result in stabilized conductive nanoparticles having a narrow particle size distribution. Most preferably, a stoichiometric, or an excess of stabilizing agent will be employed.

The stabilized conductive nanoparticles will preferably have a particle size distribution (Rp_{w}/Rpₙ) of less than 1.3, preferably less than 1.2, with particle size distributions of less than 1.1 being achievable. Rp_{w} and Rpₙ refer to the weight average particle radius and the number average particle radius, respectively.

The ratios between the stabilizing agent and the conductive nanoparticle will be chosen to render the composite phase stable, as evidenced by its exhibition of a dielectric constant that exceeds that predicted by the rule of mixtures, without causing the size of the stabilized conductive nanoparticle to be so large as to be incapable of formation into the desired thin films. See, for example, Hamley, I. W., Introduction to Soft Matter: Polymers Colloids, Amphiphiles and Liquid Crystals, Wiley, New York, (2000), for general theoretical calculations that may be employed to determine appropriate amounts of stabilizing agent.

The stabilized conductive nanoparticles will preferably be dispersed within the matrix polymer in an amount sufficient to yield a composite having a dielectric constant in excess of what is predicted by the rule of mixtures. In particular, the conductive nanoparticles will be provided to the composite in an amount sufficient to yield a composite having a dielectric constant that obeys the following inequality:

κ_{eff}>κₘₐₜᵣᵢₓ*(1+3Φ),

preferably,

κ_{eff}>2*κₘₐₜᵣᵢₓ*(1+3Φ),

and, more preferably

κ_{eff}>3*κₘₐₜᵣᵢₓ*(1+3Φ),

where κ_{eff} is the dielectric constant of said composite, κₘₐₜᵣᵢₓ is the dielectric constant of said matrix polymer and Φ is the volume fraction of said stabilized conductive nanoparticles within said composite.

Typically, the stabilizing agent will be present in the composite in an amount of at least 1 weight percent. Typically, the stabilizing agent will be present in the composite in an amount of less than 10 weight percent, preferably less than 5 weight percent.

Preferably, the dielectric constant of the composites of the invention will be at least 8, more preferably at least 12 and most preferably at least 15. Composites having a dielectric constant of less than 100, typically less than 75, and most typically less than 50, will be suitable for most applications.

In the preferred embodiment where the stabilized conductive nanoparticles are stabilized conductive gold nanoparticles, the stabilized conductive nanoparticles will preferably be provided to the composite in the amount of at least 1.5 percent by volume of the composite, more preferably provided to the composite in the amount of at least 2 percent by volume of the composite, and most preferably at least 3 percent by volume of the composite. The stabilized conductive nanoparticles will preferably not be provided to the composite in an amount that exceeds the level at which the viscosity of a solution-processible formulation of the composite exceeds that suitable for the contemplated application. Typically, the stabilized conductive nanoparticles will be provided to the composite in an amount less than 15, more typically less than 10 percent by volume of the composite.

The composites of the invention may be prepared by techniques known in the art, such as solution mixing, in-situ polymerization, and melt processing. In the case of solution mixing, the stabilized conductive nanoparticles may be mixed with the matrix polymer, in a compatible solvent, with the composite being subsequently isolated therefrom.

In the case of in-situ polymerization, the stabilized conductive nanoparticles are dispersed within a reactive solvent, the reactive solvent may be a monomer, oligomer, or mixture thereof, from which the matrix polymer may be formed. As the reactive solvent reacts to form the matrix polymer, the stabilized conductive nanoparticles are incorporated into the matrix polymer. When the matrix polymer is a thermosetting polymer, such a thermosetting polymer will preferably be formed by partially polymerizing the monomers as a B-staged material, wherein the conversion of the monomers is advanced to a defined and controlled value which is lower than the value at which the system would reach the onset of chemical gelation. To control the viscosity of the B-staged material, a non-reactive solvent may be added to the unreacted monomers, or added to the B-staged material.

In the case of melt-processing, stabilized conductive nanoparticles may be introduced into the molten matrix polymer, such as via a side-feed to an extruder, or by other means known in the art.

The composites of the invention may optionally contain one or more additives. For instance, fillers, colorants, and processing aids may be employed, to the extent they do not interefere with the beneficial attributes of the composites. When employed, such additives will typically be provided in an amount of less than 1.0 percent, preferably less than 0.5 percent by weight of the composite.

Likewise, to facilitate the achieving and maintenance of a uniform dispersion of the stabilized conductive nanoparticles within the matrix polymer, a supplemental compatibilizing agent may be employed. Exemplary compatibilizing agents include, for example, polycaprolactone polymers. When employed, such compatibilizing agents will typically be provided in an amount of less than 5 percent, preferably less than 1 percent by weight of the composite. However, preferably, compatibilization of the stabilized conductive nanoparticles within the matrix polymer will be achieved by the design of the stabilized conductive nanoparticles. As discussed above, thiol-functionalized polycaprolactone is an especially preferred stabilizing agent, as, in addition to stabilizing the conductive nanoparticles, it also serves to compatibilize the conductive nanoparticles within the matrix polymer.

The composites of the invention may be deposited as films onto substrates by various film forming techniques, including but not limited to spin-coating, spray-coating, ink jet deposition, ink pad stamping, casting, extrusion coating, and knife blade application. For use in electronic applications, the films will preferably have a thickness of less than 3 microns, preferably less than 2 microns, more preferably less than 1 micron. Advantageously, the films prepared are continuous, meaning they, despite their thin character, are free of pinholes or voids of a diameter greater than 0.001 micron. Accordingly, the films will typically have a thickness of at least 0.02 microns.

The resultant films will preferably have a bulk resistance of at least 10⁸ ohm-cm, typically from 10⁸ to 10¹⁰ ohm-cm. The resultant films will preferably have a dielectric constant-frequency response that is flat over the frequency range of 1 to 10⁵ Hz, with dielectric constant being determined at different frequencies, in accordance with the procedure set forth in the Examples.

In one embodiment, the films may be post-cured to impart additional heat and solvent resistance. For instance, when the matrix polymer is a B-staged material, in an especially preferred embodiment, the films, once applied to the substrate, will be further cured. Typically, such post-curing regimes include heating in the presence of a crosslinking agent, UV curing, and e-beam curing.

The composites of the invention will find utility in capacitive dielectrics, gate insulators in thin film transistors and field-effect transistor circuitry, and “on-board” chip memory.

Organic thin film transistors are disclosed in U.S. Pat. No. 6,204,515 B1, incorporated herein by reference. In particular, an organic thin film transistor is a planar, two-dimensional electrical switch that possesses an organic semiconductor as the active material. When “ON”, the source and drain electrodes are electrically connected. When “OFF”, they are disconnected. Operation is dictated by use of a third gate electrode. Organic thin film transistors are formed by sequentially depositing the electrodes on a substrate in the form of thin films.

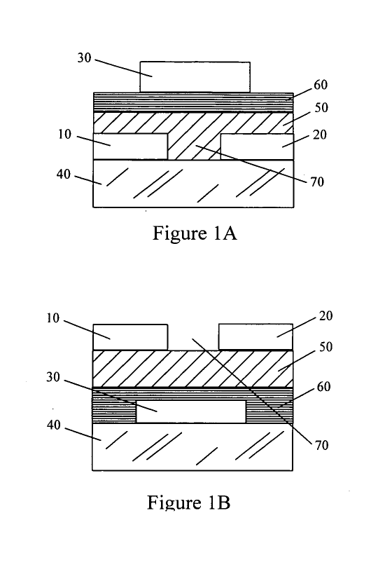

FIG. 1 depicts two typical thin-film transistor structures for an organic thin film transistor. FIG. 1A illustrates the “gate-up” design. In this design, source electrode 10 and drain electrode 20 are fabricated using selective metal deposition or lithography on a substrate 40. Substrate 40 may be formed of any material of convenience (glass, silicon, etc.). A thin film of semiconducting polymer 50 is applied to substrate 40. Then, an insulating gate dielectric film 60 is applied. Finally, the gate electrode 30 is applied on top of insulating gate dielectric film 60, positioned above source-drain gap 70.

FIG. 1B illustrates the “gate-down” design. In this design, the gate electrode 30 is applied to substrate 40 using selective metal deposition or lithography. Upon this structure, an insulating gate dielectric film 60 is applied, and upon this layer the semiconducting polymer 50 is applied as a thin film. On top of this, the source electrode 10 and the drain electrode 20 are deposited and positioned so that the source-drain gap 70 is directly above gate electrode 30.

Organic thin film transistors operate by electrical induction (also known as a “field effect”), whereby the gate electrode is biased using an applied voltage. This applied voltage sets up an electric field in the insulating gate dielectric, which polarizes it. This polarization causes the organic semiconducting layer to accumulate charge. The greater the charge accumulation in the organic semiconducting layer, the greater the source-drain current. Hence, utilizing an insulating gate dielectric with a high degree of polarization will permit lower gate operating voltages to activate the source-drain switch. Preferably, the insulating gate dielectric will be formed of the composite of the claimed invention.

Other components of the organic thin film transistors of the invention may be selected as is known in the art. Exemplary substrates include silicon, glass, polymer, epoxy laminated board, ceramic and fabric. Organic semiconducting materials will have conjugated pi-bond systems. Exemplary organic semiconducting materials include polyfluorene, polyacetylene, poly-2-vinylpyridine, polyphenylacetylene, polyphenylene, polyphenylene sulfide, polypyrrole, polyacrylonitrile, polyheptadiyne, polymethylacetylene, polyphenylene vinylene, and polyphenylene oxide. The semiconducting materials, to the extent they are not intrinsic semiconductors, may be doped to improve their conductivity. Typical dopants include arsenic pentafluoride, elemental iodine, and thiophenes. Source, drain and gate electrodes are generally made from metal, such as aluminum or gold, although conductive polymers may be employed.

### EXAMPLES

Test Procedure: Measurement of Dielectric Constant

The dielectric coefficient (or dielectric constant) of a material may be determined by incorporating the material as a dielectric filler between the plates of a test capacitor geometry.

With a dielectric filler, the fundamental equation of capacitance is given by:

$$C = \frac{κ {ϵ}_{0} A}{d}$$

where C is the capacitance (a measured quantity), κ is the dielectric coefficient, ε₀ is the permittivity of free space (a fundamental physical constant, equal to 8.85×10⁻¹² F/m), A describes the area of the capacitor and d describes the thickness of the dielectric film or layer inside the capacitor. To determine the dielectric coefficient, κ, we fabricate a test capacitor with known geometrical characteristics A and d, and measure the capacitance C to determine:

$$κ = C ( \frac{d}{{ϵ}_{0} A} )$$

The area of the capacitor is known, and the film thickness is measured. The capacitance is measured at 1-MHz using a standard capacitance meter system purchased from Agilent Technologies (Agilent 4285A Precision LCR Meter, Agilent technologies, Englewood, Colo., USA).

For reference, the dielectric constant of polystryene was measured in accordance with this procedure and was found to be 2.55 to 2.65.

The following Examples 1-3 illustrate the preparation of a composite of dodecanethiol-functionalized gold conductive nanoparticles in a polystyrene matrix polymer.

Test Procedure: Measurement of Particle Size and Particle Size Distribution

A drop of a solution of the stabilized conductive nanoparticle in toluene or tetrahydrofuran is placed on a copper transmission electron microscopy (TEM) grid. The solvent is permitted to evaporate.

TEM images of the stabilized conductive nanoparticles are taken. The resultant TEM images are transformed into .jpg files and are read into a “paint” software package, wherein the grey scale is reversed. The resultant file is read into image analysis software. The software measures the particle diameter of from 300 to 500 stabilized conductive nanoparticles, and calculates the mean particle radius. The software further plots the particle size distribution from which the breadth of the distribution (Rp_{w}/Rpₙ) may be calculated.

### Example 1

(i) Preparation of Dodecanethiol Functionalized Gold Nanoparticles Having a Ratio of Gold to Sulfur, [Au]/[S] of 0.913

0.83 g (4.12 mmol) of dodecanthiol was added under vigorous stirring to a solution of hydrogen tetrachloroauric acid trihydrate (H.AuCl₄0.3H₂O) (1.77 g, 4.49 mmol) in 63 cm³ tetrahydrofuran, under a nitrogen atmosphere. The solution immediately turned from a straw-yellow color to orange-brown color. The reaction mixture was stirred for approximately 20 minutes at room temperature. After this time, 5 cm³ of a 1.0 M solution of lithium triethylborohydride (superhydride) in tetrahydrofuran was added dropwise, with the aid of a syringe fitted with a Leur lock. The mixture immediately turned dark red-brown and slowly transformed to a dark brown-purple coloration. The reaction was allowed to proceed for approximately 90 minutes.

Samples were extracted for UV-visible spectroscopy (UV-vis), transmission electron microscopy (TEM), ion concentration, and particle surface characterization. The remaining mixture was collected and stored under nitrogen, in a dark brown, glass receptacle. The cap was sealed with PARAFILM™ self-sealing film and the container was wrapped and sealed completely in silver foil and placed in a refrigerator to prevent photolytic degradation and oxidation.

Based upon the stoichiometry employed, the molar ratio of gold to sulphur was 0.913. The gold content was calculated to be 1.26% (w/w).

(ii) Preparation of Solution of the Matrix Polymer

A 10% (w/w) polymer solution of polystyrene (Dow STYRON* PS-665) was prepared from filtered (0.22 μm filter), high purity liquid chromatography grade toluene.

(iii) Preparation of Composite Solutions of the Matrix Polymer and the Stabilized Conductive Nanoparticles; Preparation of Films of the Composite on a Doped Silicon Wafer

As set forth in Table One, aliquots of the matrix polymer solution of (ii) and the dodecanethiol functionalized gold nanoparticle/tetrahydrofuran solution of (i) were mixed. The composite solutions were spin-coated onto a n-doped silicon wafer and dried at 130° C. for 1 hour in a nitrogen glove box. Composite film thicknesses ranged from 1000 to 10,000 Å, depending upon the polymer concentration and spin-coating speed adopted. The final concentration of elemental gold in the composite film varied from 0 to 35% w/w, and is further reported in Table One.

(iv) Preparation of Capacitor Assemblies

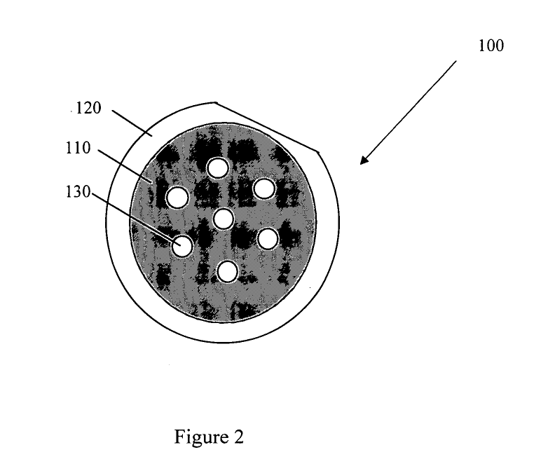

The composite-doped silicon wafer structures of (iii) were fabricated into capacitor assemblies. The capacitor layout on the wafer is depicted in FIG. 2. Specifically, each capacitor 100 is formed by depositing a composite film 110 of the invention onto a n-doped silicon wafer 120, by the spin coating process recited in (iii) above. Then, using a Balzers vacuum evaporator, circular pads of silver metal 130 are vacuum deposited onto composite film 110 to form capacitors. In these capacitor assemblies, the doped silicon wafer 120 serves as the bottom electrode, and the composite film 110 serves as the dielectric.

An Agilent 4285 Precision LCR meter was employed for characterizing the test capacitor structures. The dielectric constant of the composite films was determined using the procedure set forth above. The same capacitor structures were employed to measure the resistivity of the composite films, using an Agilent 4339B high Resistance Meter and a TENMA multimeter. Based on the known areas of the capacitor and the film thickness, the resistance of the composite films was calculated. Relevant formula utilized are:

$$C = κ \frac{{ϵ}_{0} A}{d}$$

where C is the measured capacitance, κ is the dielectric constant for the dielectric, ∈₀ is the permittivity of free space (a fundamental physical constant), A is the area of the capacitor and d refers to the thickness of the dielectric film under measurement.

$$ρ = \frac{RA}{d}$$

where ρ is the film resistance in ohm-cm, R is the measured resistivity in ohms, A is the area of the capacitor electrodes and d is the thickness of the film being measured.

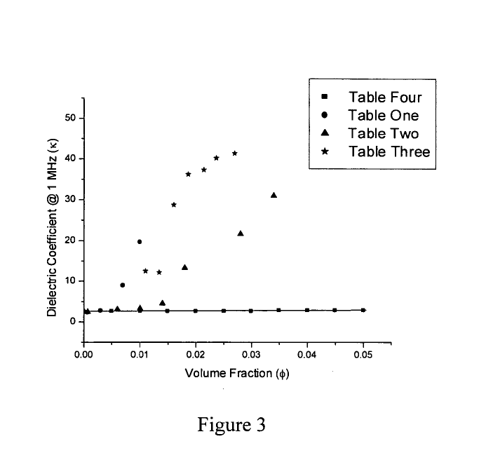

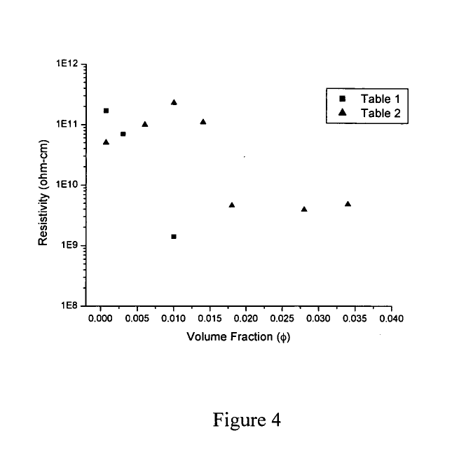

For statistical assurance, sets of seven readings of each measurement of dielectric constant were made, with the average of each set being set forth in Table One. The results are further graphically represented in FIGS. 3 and 4.

TABLE ONE

| | Mass | | | | | |
|---|---|---|---|---|---|---|
| | of polystyrene/ | Mass of | weight | | | |
| | toluene | gold/THF | fraction | volume fraction | Resistance | Dielectric |
| Sample | solution (g) | solution (g) | of gold | of gold | (ohm-cm) | Constant |
| 1-A | 5.45 | 0.55 | 0.012 | 0.000(7) | 1.7 × 10¹¹ | 2.37 |
| 1-B | 4.35 | 1.65 | 0.045 | 0.003 | 7.0 × 10¹⁰ | 2.74 |
| 1-C | 3.15 | 2.85 | 0.100 | 0.007 | N/D | 8.97 |
| 1-D | 2.50 | 3.50 | 0.150 | 0.010 | 1.4 × 10⁹ | 19.70 |

### Example 2

(i) Preparation of Dodecanethiol Functionalized Gold Nanoparticles Having a Ratio of Gold to Sulfur, [Au]/[S] of 0.827

1.1061 g (5.46 mmol) of 1-dodecanthiol was added under vigorous stirring to a solution of hydrogen tetrachloroauric acid trihydrate (H.AuCl_{40.3}H₂O) (1.7782 g, 4.51 mmol) in 60 cm³ tetrahydrofuran, under a nitrogen atmosphere. The solution immediately turned from a straw-yellow color to orange-brown. The reaction mixture was stirred for approximately 20 minutes at room temperature. After this time, 5 cm³ of a 1.0 M solution of lithium triethylborohydride (superhydride) in tetrahydrofuran was added dropwise, with the aid of a syringe fitted with a Leur lock. The mixture immediately turned dark red-brown and slowly transformed to a dark brown-purple color. The reaction was allowed to proceed for approximately 90 minutes.

Samples were extracted for UV-visible spectroscopy (UV-vis), transmission electron microscopy (TEM), ion concentration, and particle surface characterization. The remaining mixture was collected and stored under nitrogen, in a dark brown, glass receptacle. The cap was sealed with PARAFILM™ self-sealing film and the container was wrapped and sealed completely in silver foil and placed in a refrigerator to prevent photolytic degradation and oxidation.

Based upon the stoichiometry employed, the molar ratio of gold to sulphur was 0.827. The gold content was calculated to be 1.44% (w/w).

(ii) Preparation of Solution of the Matrix Polymer

A 10% (w/w) polymer solution of polystyrene (Dow STYRON* PS-665) was prepared from filtered (0.22 μm filter), high purity liquid chromatography grade toluene.

(iii) Preparation of Composite Solutions of the Matrix Polymer and the Stabilized Conductive Nanoparticles; Preparation of Films of the Composite on a Doped Silicon Wafer

As set forth in Table Two, aliquots of the matrix polymer solution of (ii) and the dodecanethiol functionalized gold nanoparticle/tetrahydrofuran solution of (i) were mixed. The composite solutions were spin-coated onto a doped silicon wafer and dried at 130° C. for 1 hour in a nitrogen glove box. Composite film thicknesses ranged from 1000 to 10,000 Å, depending upon the polymer concentration and spin-coating speed adopted. The final concentration of elemental gold in the composite film varied from 0 to 40% w/w, and is further reported in Table Two.

(iv) Preparation of Capacitor Assemblies

The composite-doped silicon wafer structures of (iii) were fabricated into capacitor assemblies in accordance with the procedure set forth in part (iv) of Example 1. The dielectric constant and the resistivity of the composite films was determined using the procedures set forth above. For statistical assurance, seven readings of each measurement were made, with the average being set forth in Table Two. The results are further graphically represented in FIGS. 3 and 4.

TABLE TWO

| | Mass of | Mass of | weight | volume | | |
|---|---|---|---|---|---|---|
| | polystyrene/toluene | gold/THF | fraction | fraction | Resistance | Dielectric |
| Sample | solution (g) | solution (g) | of gold | of gold | (ohm-cm) | Constant |
| 2-A | 5.55 | 0.45 | 0.012 | 0.000(7) | 5.0 × 10¹⁰ | 2.48 |
| 2-B | 3.40 | 2.60 | 0.100 | 0.006 | 1.0 × 10¹¹ | 3.07 |
| 2-C | 3.30 | 2.70 | 0.150 | 0.010 | 2.3 × 10¹¹ | 3.37 |
| 2-D | 2.15 | 3.85 | 0.205 | 0.014 | 1.1 × 10¹¹ | 4.54 |
| 2-E | 1.80 | 4.20 | 0.251 | 0.018 | 4.6 × 10⁹ | 13.30 |
| 2-F | 1.25 | 4.75 | 0.347 | 0.028 | 3.9 × 10⁹ | 21.68 |
| 2-G | 1.10 | 4.90 | 0.391 | 0.034 | 4.8 × 10⁹ | 31.01 |

### Example 3

(i) Preparation of Dodecanethiol Functionalized Gold Nanoparticles Having a Ratio of Gold to Sulfur, [Au]/[S] of 0.822

2.6778 g (13.23 mmol) of 1-dodecanthiol was added under vigorous stirring to a solution of hydrogen tetrachloroauric acid trihydrate (H.AuCl₄0.3H₂O) (4.2810 g, 10.87 mmol) in 56 cm³ tetrahydrofuran, under a nitrogen atmosphere. The solution immediately turned from a straw-yellow color to orange-brown. The reaction mixture was stirred for approximately 20 minutes at room temperature. After this time, 14 cm³ of a 1.0 M solution of lithium triethylborohydride (superhydride) in tetrahydrofuran was added dropwise, with the aid of a syringe fitted with a Leur lock. The mixture immediately turned dark red-brown and slowly transformed to a dark brown-purple color. The reaction was allowed to proceed for approximately 90 minutes.

Samples were extracted for UV-visible spectroscopy (UV-vis), transmission electron microscopy (TEM), ion concentration, and particle surface characterization. The remaining mixture was collected and stored under nitrogen, in a dark brown, glass receptacle. The cap was sealed with PARAFILM™ self-sealing film and the container was wrapped and sealed completely in silver foil and placed in a refrigerator to prevent photolytic degradation and oxidation.

Based upon the stoichiometry employed, the molar ratio of gold to sulphur was 0.822. The gold content was calculated to be 3.08% (w/w).

The mean particle size and particle size distribution of the stabilized conductive nanoparticles was determined. The mean particle radius was 2.50±0.10 nm. The particle size distribution was 1.06.

(ii) Preparation of Composite Solutions of the Matrix Polymer and the Stabilized Conductive Nanoparticles; Preparation of Films of the Composite on a Doped Silicon Wafer

As set forth in Table Three, a defined amount of polystyrene (Dow STYRON* PS-665) was added to 5.0 g of the dodecanethiol functionalized gold nanoparticle/tetrahydrofuran solution of (i). The resulting composite solutions were mixed with a mechanical shaker and then spin-coated onto a doped silicon wafer and dried at 130° C. for 1 hour in a nitrogen glove box. Composite film thicknesses ranged from 1000 to 10,000 Å, depending upon the polymer concentration and spin-coating speed adopted. The final concentration of elemental gold in the composite film varied from 0 to 34% w/w, and is further reported in Table Three.

(iii) Preparation of Capacitor Assemblies

The composite-doped silicon wafer structures of (ii) were fabricated into capacitor assemblies in accordance with the procedure set forth in part (iv) of Example 1. The dielectric constant and the resistivity of the composite films was determined using the procedures set forth above. For statistical assurance, seven readings of each measurement were made, with the average being set forth in Table Three. The results are further graphically represented in FIGS. 3 and 4.

TABLE THREE

| | Mass of | Mass of | Weight | Weight | Volume | |
|---|---|---|---|---|---|---|
| | gold/THF | polystyrene | fraction of | fraction of | fraction of | Dielectric |
| Sample | solution (g) | (g) | polystyrene | gold | gold | Constant |
| 3-A | 5.0792 | 0.7648 | 0.131 | 0.170 | 0.0110 | 12.50 |
| 3-B | 5.0251 | 0.6154 | 0.109 | 0.200 | 0.0134 | 12.17 |
| 3-C | 5.0177 | 0.5171 | 0.093 | 0.230 | 0.0160 | 28.75 |
| 3-D | 5.0266 | 0.4426 | 0.081 | 0.259 | 0.0186 | 36.29 |
| 3-E | 5.0135 | 0.3845 | 0.071 | 0.287 | 0.0214 | 37.36 |
| 3-F | 5.0102 | 0.3466 | 0.065 | 0.308 | 0.0236 | 41.40 |
| 3-G | 5.0012 | 0.3025 | 0.057 | 0.337 | 0.0269 | 40.24 |

For comparative purposes, the dielectric constant of composites of gold in a polystyrene polymer matrix, as predicted by the rule of mixtures, is set forth in the following Table Four.

TABLE FOUR

| Volume fraction of gold | Dielectric Constant |
|---|---|
| 0.0000 | 2.50 |
| 0.0050 | 2.54 |
| 0.0100 | 2.59 |
| 0.0150 | 2.61 |
| 0.0200 | 2.65 |
| 0.0250 | 2.69 |
| 0.0300 | 2.72 |
| 0.0350 | 2.76 |
| 0.0400 | 2.80 |
| 0.0450 | 2.84 |
| 0.0500 | 2.88 |

As illustrated in FIG. 3, the composites of the invention demonstrate a dielectric constant that greatly exceeds that of the polystyrene matrix polymer (the dielectric constant of pure polystyrene being 2.5). As illustrated in FIG. 3, the composites of the invention demonstrate a dielectric constant that exceeds that predicted by the rule of mixtures.

As shown in FIG. 3 and the foregoing tables, composites having a dielectric constant of greater than 8, preferably greater than 12, more preferably greater than 15, and most preferably greater than 20 may be prepared. Indeed, composties having dielectic constants of greater than 30, and even greater than 40 have been successfully demonstrated.

As illustrated in FIG. 4, the composites of the invention exhibit an electrical resistance in excess of 1 gigaohm-cm. The combination of high dielectric constant, high resistance, and ease of use in solvent-based film forming processes will make the composites of the invention highly desirable in electronics applications, such as the dielectric gate of an organic transistor, as well as specialized circuit board laminates.

The following Examples 4-6 illustrate the preparation of a composite of polyester-thiol-functionalized gold conductive nanoparticles in a polystyrene matrix polymer.

### Examples 4-6

### Preparation of Polyester-thiol Functionalized Gold Nanoparticles

(i) Preparation of the Thiol-Functionalized Polycaprolactone Stabilizing Precursor Agent

Polycaprolactones with a central disulphide moiety were synthesized from the ring opening polymerization of ε-caprolactone with bis(2-hydroxyethyl) disulphide. Three poly(caprolcatones) prepared from [ε-CL]:[initiator] ratios of 8, 6 and 4:1, respectively, were synthesized as Examples 4, 5, and 6, respectively, and characterized by ¹H and ¹³C n.m.r spectroscopy. The resultant mole % of oligomeric poly(caprolactone) for Examples 4, 5, and 6 was 80%, 74.4% and 63%, respectively. The ring-opening polymerization to yield the poly(caprolactone) results in a Poisson type distribution of molar mass.

(ii) Example 4. Preparation of Composite Solution in which [ε-CL]:[initiator]=8:1 and [Au]: [S]=0.991

Thus, 0.6097 g (2.16 mmol S per g of polymer) of the disulphide functionalized, poly(caprolactone) of (i) was added to 9.16 cm³ of tetrahydrofuran and subjected to stirring with a glass rod. Dissolution of the poly(caprolcatone) occurred within a matter of 1 to 2 minutes. 0.5127 g (1.3 mmol) of hydrogen tetrachloroauric acid trihydrate (H[AuCl₄]0.3H₂O) were added to 9.68 cm³ tetrahydrofuran, and subjected to stirring with a glass rod. The two solutions were mixed intimately with the aid of a magnetic stirrer bar, under a nitrogen atmosphere. Upon contact, the solution turned from a straw-yellow color to orange-brown immediately. The reaction mixture was stirred for approximately 1 hour at room temperature. After this time, 3 cm³ of a 1.0 M solution of lithium triethylborohydride (superhydride) in tetrahydrofuran was added dropwise, with the aid of a syringe, fitted with a Leur lock. The mixture turned dark red-brown immediately and slowly transformed to a dark brown-purple coloration. The reaction was allowed to proceed for approximately 2 hours. Samples were extracted for UV-visible spectroscopy (UV-vis), transmission electron microscopy (TEM), ion concentration, and particle surface characterization. The remaining mixture was collected and stored under nitrogen, in a dark brown, glass receptacle. The cap was sealed with PARAFILM™ self-sealing film and the container was wrapped and sealed completely in silver foil and placed in a refrigerator to prevent photolytic degradation and oxidation.

(iii) Example 5. Preparation of Composite Solution in which [ε-CL]:[initiator]=6:1 and [Au]:[S]=1.006

Thus, 0.5029 g (2.66 mmol S per g of polymer) of the disulphide functionalized, poly(caprolactone) was added to 9.57 cm³ of tetrahydrofuran and subjected to stirring with a glass rod. Dissolution of the poly(caprolcatone) occurred within a matter of 1 to 2 minutes. 0.5306 g (1.34 mmol) of hydrogen tetrachloroauric acid trihydrate (H[AuCl₄]0.3H₂O) were added to 9.06 cm³ tetrahydrofuran, and subjected to stirring with a glass rod. The two solutions were mixed intimately with the aid of a magnetic stirrer bar, under a nitrogen atmosphere. Upon contact, the solution turned from a straw-yellow color to orange-brown immediately. The reaction mixture was stirred for approximately 1 hour at room temperature. After this time, 3 cm³ of a 1.0 M solution of lithium triethylborohydride (superhydride) in tetrahydrofuran was added dropwise, with the aid of a magnetic stirrer bar, under a nitrogen atmosphere. Upon contact, the solution turned from a straw-yellow color to orange-brown immediately. The reaction mixture was stirred for approximately 1 hour at room temperature. After this time, 3 cm³ of a 1.0 M solution of lithium triethylborohydride (superhydride) in THF was added dropwise, with the aid of a syringe, fitted with a Leur lock. The mixture turned dark red-brown immediately and slowly transformed to a dark brown-purple coloration. The reaction was allowed to proceed for approximately 2 hours. Samples were extracted for UV-visible spectroscopy (UV-vis), transmission electron microscopy (TEM), ion concentration, and particle surface characterization. The remaining mixture was collected and stored under nitrogen, in a dark brown, glass receptacle. The cap was sealed with PARAFILM™ self-sealing film and the container was wrapped and sealed completely in silver foil and placed in a refrigerator to prevent photolytic degradation and oxidation.

(iv) Example 6. Preparation of Composite Solution in which [ε-CL]:[initiator]=4:1 and [Au]:[S]=1.019

Thus, 0.3637 g (3.55 mmol S per g of polymer) of the disulphide functionalized, poly(caprolactone) was added to 9.65 cm³ of tetrahydrofuran and subjected to stirring with a glass rod. Dissolution of the poly(caprolcatone) occurred within a matter of 1 to 2 minutes. 0.5181 g (1.32 mmol) of hydrogen tetrachloroauric acid trihydrate (H[AuCl₄]0.3H₂O) were added to 9.00 cm³ tetrahydrofuran, and subjected to stirring with a glass rod. The two solutions were mixed intimately with the aid of a magnetic stirrer bar, under a nitrogen atmosphere. Upon contact, the solution turned from a straw-yellow color to orange-brown immediately. The reaction mixture was stirred for approximately 1 hour at room temperature. After this time, 3 cm³ of a 1.0 M solution of lithium triethylborohydride (superhydride) in tetrahydrofuran was added dropwise, with the aid of a syringe, fitted with a Leur lock. The mixture turned dark red-brown immediately and slowly transformed to a dark brown-purple coloration. The reaction was allowed to proceed for approximately 2 hours. Samples were extracted for UV-visible spectroscopy (UV-vis), transmission electron microscopy (TEM), ion concentration, and particle surface characterization. The remaining mixture was collected and stored under nitrogen, in a dark brown, glass receptacle. The cap was sealed with PARAFILM™ self-sealing film and the container was wrapped and sealed completely in silver foil and placed in a refrigerator to prevent photolytic degradation and oxidation.

What is claimed:

1. A composite comprising a poly(methyl methacrylate) matrix having dispersed therein conductive transition metal nanoparticles, which dispersion is stabilized by a thiol-functionalized stabilizing agent, wherein the difference between the solubility parameter of the poly(methyl methacrylate) and the stabilizing agent is less than or equal to 3.

2. The composite of claim 1 wherein the volume/volume concentration of the nanoparticles in the poly(methyl methacrylate) matrix is in the range of 1.5 to 10 percent and wherein the solubility parameter of the poly(methyl methacrylate) and the stabilizing agent is less than or equal to 2.

3. The composite of claim 2 wherein the conductive nanoparticles are gold or silver.

4. The composite of claim 3 wherein the conductive nanoparticles are gold and wherein the thiol functionalized stabilizing agent is dodecanethiol or octadecanethiol or a thiol-functionalized block copolymer or a thiol-compatibilized polycaprolactone or combinations thereof.

5. The composite of claim 3 wherein the stabilizing agent is present in the composite in an amount in the range of from 1 to 10 weight percent.

6. The composite of claim 2 which is mixed with a compatible solvent to make an ink.

7. The composite of claim 6 wherein the solvent is propyleneglycolmonomethylether acetate, ethyl acetate, isopropyl acetate, butyl acetate, tetrahydrofuran, toluene, xylenes, or mesitylenes.
